(19) United States
(12) Patent Application Publication
(10) Pub. No.: US 2007/0198315 A1
(43) Pub. Date: Aug. 23, 2007

(54) Distribution of business documents to multiple parties

(76) Inventors: Satyesh Singh, (US); Prashant Kumar Singhai, (US)

Correspondence Address: MINTZ, LEVIN, COHN, FERRIS, GLOVSKY & POPEO, P.C., 9255 TOWNE CENTER DRIVE, SUITE 600, SAN DIEGO, CA, 92121, US

(21) Appl. No.: 11/349,275

(22) Filed: Feb. 7, 2006

(51) Int. Cl. G05B 19/418; G06F 15/02

(52) U.S. Cl. 705/8; 705/9

(57) ABSTRACT

A method for generating business documents includes generating a primary business document from one party to a business transaction for another party to a business transaction. It is determined whether to apply a customization to the primary business document. An intermediary business document is generated responsive to determining whether to apply a customization to the primary business document for an intermediary to the business transaction.

### BACKGROUND

1. Technical Field

The present disclosure relates to business documents and, more specifically, to distribution of business documents to multiple parties.

2. Description of the Related Art

As modern business becomes increasingly competitive, great pressure is placed upon marketing and/or sales departments to generate new customers. As a result, many businesses have become increasingly dependant upon third party business partners for finalizing deals between the business and its new customers.

Often, these business partners may be entitled to some portion of revenue generated from the business deals they helped to finalize. It is therefore important to utilize simple and effective tools for maintaining transparency in these business deals so third parties may be kept well informed of the particulars surrounding the business's deals that they helped to finalize.

Moreover, other situations exist in which one or more third parties or internal departments may wish to remain apprised of certain business transactions within the particular business. For example, intermediaries, business partners, government oversight agencies and internal oversight agencies such as auditors, accountants and lawyers may all have an interest in being kept inform of certain business transactions.

As many modern businesses utilize comprehensive software solutions for managing business transactions and more generally, customer relations. One example of such a software solution is Customer Relationship Management (CRM).

Typical CRM software packages help to organize and manage information critical to all elements of customer interaction and lay a foundation for effective process and procedure adherence so that a desired business strategy can more effectively be implemented.

One conventional feature of CRM software packages is to generate business documents such as purchase orders that may be used in the execution of business deals. While current CRM software packages may be able to generate certain business documents for direct presentation to parties such as customers and suppliers, these business documents are not well suited for third-party business partners, such as business deal finalizers, and other sorts of intermediaries generally because of the absence of information pertinent to the intermediary and the presence of information that might not be appropriate to share with intermediaries, such as confidential customer information.

It is therefore desirable to provide CRM software with the capabilities of generating business documents for third-party business partners such as deal-makers and other intermediaries.

### SUMMARY

A method for generating business documents includes generating a primary business document from one party to a business transaction for another party to a business transaction. It is determined whether to apply a customization to the primary business document. An intermediary business document is generated responsive to determining whether to apply a customization to the primary business document for an intermediary to the business transaction.

A system for generating business documents includes a primary business document generating unit for generating a primary business document from one party to a business transaction for another party to a business transaction. A determining unit determines whether to apply a customization to the primary business document. An intermediary business document generating unit generates an intermediary business document responsive to determining whether to apply a customization to the primary business document for an intermediary to the business transaction.

A computer system includes a processor and a program storage device readable by the computer system, embodying a program of instructions executable by the processor to perform method steps for generating business documents. The method includes generating a primary business document from one party to a business transaction for another party to a business transaction. It is determined whether to apply a customization to the primary business document. An intermediary business document is generated responsive to determining whether to apply a customization to the primary business document for an intermediary to the business transaction.

### BRIEF DESCRIPTION OF THE DRAWINGS

A more complete appreciation of the present disclosure and many of the attendant advantages thereof will be readily obtained as the same becomes better understood by reference to the following detailed description when considered in connection with the accompanying drawings, wherein:

FIG. 1 is a block diagram showing an embodiment of the present disclosure;

FIG. 2 is a flow chart showing a method for generating business documents according to an embodiment of the present disclosure;

FIG. 3 shows a simplified example of a primary business document and an intermediary business document according to an embodiment of the present disclosure; and

FIG. 4 shows an example of a computer system capable of implementing the method and apparatus according to embodiments of the present disclosure.

### DETAILED DESCRIPTION

In describing the preferred embodiments of the present disclosure illustrated in the drawings, specific terminology is employed for sake of clarity. However, the present disclosure is not intended to be limited to the specific terminology so selected, and it is to be understood that each specific element includes all technical equivalents which operate in a similar manner.

Embodiments of the present disclosure seek to provide CRM software with capabilities for generating customized business documents for third-party business partners such as deal-makers and other intermediaries. While there are many different types of intermediaries, perhaps the simplest example is the case where a business partner facilitates an agreement between a supplier and a customer. In such situations, the business partner may be entitled to a fee and/or commission on each sale of products from the supplier to the customer.

The customer, utilizing a CRM software solution, may generate a purchase order to request the desired products from the supplier. The purchase order is an example of a business document as it is a document that is used to conduct business. This purchase order may contain the type of product and the quantity desired. Embodiments of the present disclosure may be used to generate a second copy or a customized version of the purchase order that may be sent to the intermediary so that the business dealings between the supplier and the customer may be transparent to the intermediary. Moreover, where applicable, the business document to be sent to the intermediary may be customized to include information pertinent to the third party such as the nature of the fee or commission and exclude confidential information concerning either the supplier or the customer.

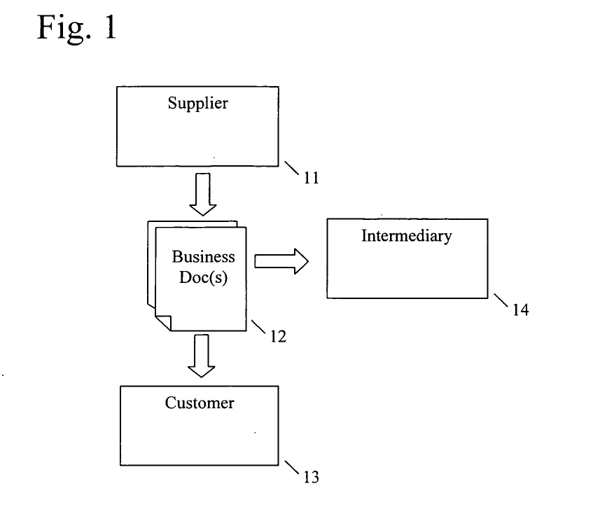

FIG. 1 is a block diagram showing an embodiment of the present disclosure. The CRM software according to embodiments of the present disclosure may be utilized by any party to the transaction. For example, the supplier 11 may use the CRM software to generate business documents 12, for example a sales order, for the customer 13 along with a copy and/or customized version of the business document 11 for the intermediary 14.

The intermediary's business document may be generated automatically, for example, along with the generation of the primary business document, and/or the intermediary's business document may be optionally generated. For example, when generating the business document, one or more output formats may be selected, for example using a post processing framework (PPF) to control the output format for the business document. In one implementation, an option is provided to select more than one “customer” for a sales order, or more than one “vendor” for a purchase order, the production of the intermediary business document may be generated. This can be configured, for example, in SPRO setting depending on the particular criteria such as product category project/service time, etc. SPRO settings are an example of an approach for customizing settings utilized by certain ERO systems.

In one embodiment, the intermediary document is a verbatim copy of the primary business document. In another embodiment, the intermediary business document is a customized version of the primary business document. The customized content depends on the desired level of transparency and the presence of potentially confidential information on the primary business document. These customizations can be established by the user or the system for customers, third-parties, documents or type of documents as further described below. In one embodiment, a customization template is used to apply the customizations to the primary business document which yields the appropriate intermediary business document. The customization template is, for example, a shell document or scripting function the implements a content filter or manipulation function.

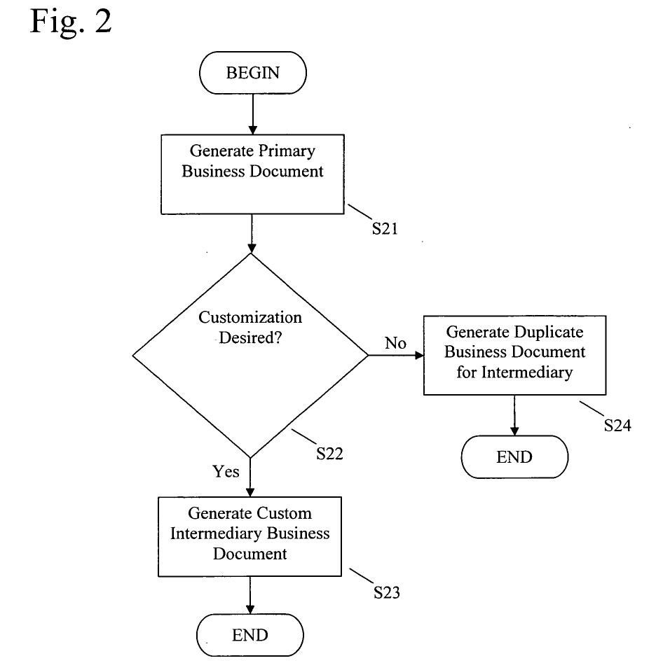

FIG. 2 is a flow chart showing a method for generating business documents according to an embodiment of the present disclosure. The primary business document may be generated (Step S21), for example, either automatically or manually. If customization is required for an intermediary's business document (yes, Step S22) then the custom intermediary business document may be generated (Step S23), either automatically or manually, according to the desired degree of transparency and the presence of confidential information. If customization is not required for an intermediary's business document (no, Step S22) then a duplicate of the primary business document may be generated for the intermediary (Step S24).

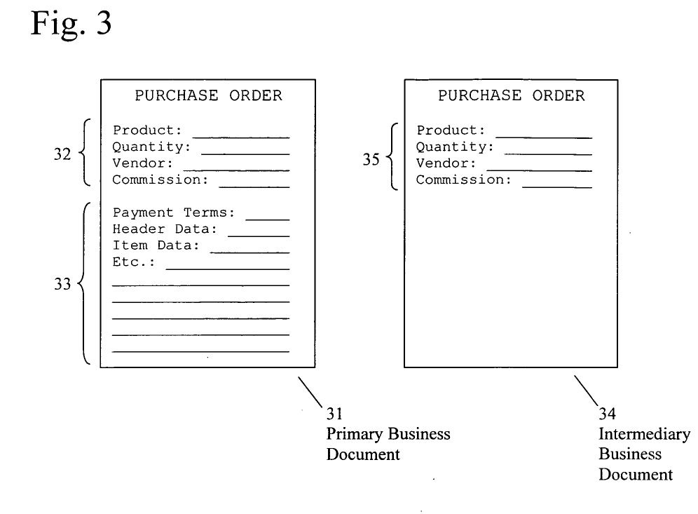

FIG. 3 shows a simplified example of a primary business document and an intermediary business document according to an embodiment of the present disclosure. The primary business document 31 may be, for example, a purchase order. The primary business document 31 may contain a listing of primary details 32 that may be of interest to the recipient of the primary document 31 and the recipient of the intermediary business document 34. The primary details may include, for example, product, quantity, vendor, commission, etc. The primary business document 31 may also contain a listing of additional details 33. The additional details 33 may be of interest to the recipient of the primary document 31 but may not be of interest to, or otherwise not appropriate for, the recipient of the intermediary business document 34. The additional details 33 may include, for example, payment terms, header data, item data, and etc. The intermediary business document 34 may contain a listing of primary details 35 matching the listing of primary details 32 in the primary business document 31.

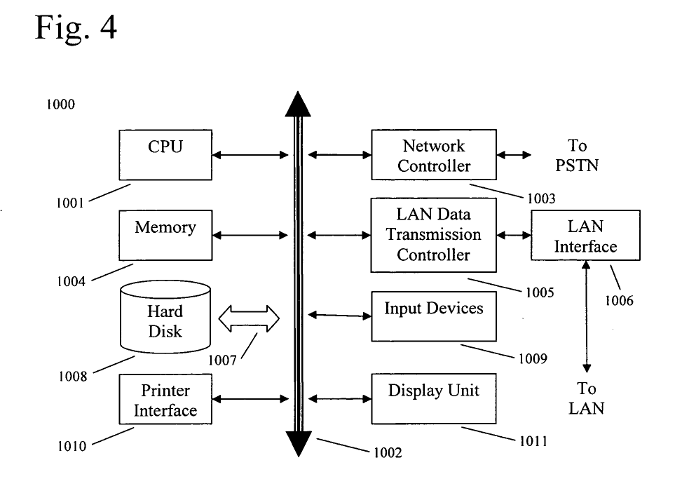

FIG. 4 shows an example of a computer system which may implement the method and system of the present disclosure. The system and method of the present disclosure may be implemented in the form of a software application running on a computer system, for example, a mainframe, personal computer (PC), handheld computer, server, etc. The software application may be stored on a recording media locally accessible by the computer system and accessible via a hard wired or wireless connection to a network, for example, a local area network, or the Internet.

The computer system referred to generally as system 1000 may include, for example, a central processing unit (CPU) 1001, random access memory (RAM) 1004, a printer interface 1010, a display unit 1011, a local area network (LAN) data transmission controller 1005, a LAN interface 1006, a network controller 1003, an internal bus 1002, and one or more input devices 1009, for example, a keyboard, mouse etc. As shown, the system 1000 may be connected to a data storage device, for example, a hard disk, 1008 via a link 1007.

The above specific embodiments are illustrative, and many variations can be introduced on these embodiments without departing from the spirit of the disclosure or from the scope of the appended claims. For example, elements and/or features of different illustrative embodiments may be combined with each other and/or substituted for each other within the scope of this disclosure and appended claims.

What is claimed is:

1. A method for generating business documents, comprising:
generating a primary business document from one party to a business transaction for another party to a business transaction;
determining whether to apply a customization to the primary business document; and
generating an intermediary business document responsive to determining whether to apply a customization to the primary business document for an intermediary to the business transaction.

2. The method of claim 1, wherein the primary business document and the intermediary business document are generated by a CRM software application.

3. The method of claim 1, wherein the primary business document is automatically or manually generated.

4. The method of claim 1, wherein the intermediary business document is automatically or manually generated.

5. The method of claim 1 wherein determining whether to apply a customization to the primary business document further comprises:
retrieving a customization template; and
applying the customization template to the primary business document to generate the intermediary business document.

6. The method of claim 5, wherein the customization template is tailored to the business transaction.

7. The method of claim 1, wherein the primary business document or the intermediary business document is manually generated by selecting a desired business document output format.

8. The method of claim 1, wherein the intermediary business document is a duplicate or a modification of the primary business document.

9. The method of claim 8, wherein the intermediary business document has been modified to remove confidential information.

10. The method of claim 8, wherein the intermediary business document has been modified to add additional information that is useful to the intermediary.

11. A system for generating business documents, comprising:
a primary business document generating unit for generating a primary business document from one party to a business transaction for another party to a business transaction;
a determining unit for determining whether to apply a customization to the primary business document; and
an intermediary business document generating unit for generating an intermediary business document responsive to determining whether to apply a customization to the primary business document for an intermediary to the business transaction.

12. The system of claim 11, wherein the primary business document and the intermediary business document are generated by a CRM software application.

13. The system of claim 11, wherein the primary business document is automatically or manually generated.

14. The system of claim 11, wherein the intermediary business document is automatically or manually generated.

15. The system of claim 11 wherein the determining unit for determining whether to apply a customization to the primary business document further comprises:
a retrieving unit for retrieving a customization template; and
an applying unit for applying the customization template to the primary business document to generate the intermediary business document.

16. The system of claim 15, wherein the customization template is tailored to the business transaction.

17. The system of claim 11, wherein the primary business document or the intermediary business document is manually generated by selecting a desired business document output format.

18. The system of claim 11, wherein the intermediary business document is a duplicate or a modification of the primary business document.

19. The system of claim 18, wherein the intermediary business document has been modified to remove confidential information.

20. The system of claim 18, wherein the intermediary business document has been modified to add additional information that is useful to the intermediary.

21. A computer system comprising:
a processor; and
a program storage device readable by the computer system, embodying a program of instructions executable by the processor to perform method steps for generating business documents, the method comprising:
generating a primary business document from one party to a business transaction for another party to a business transaction;
determining whether to apply a customization to the primary business document; and
generating an intermediary business document responsive to determining whether to apply a customization to the primary business document for an intermediary to the business transaction.

22. The computer system of claim 21, wherein the primary business document and the intermediary business document are generated by a CRM software application.

23. The computer system of claim 21, wherein the primary business document is automatically or manually generated.

24. The computer system of claim 21, wherein the intermediary business document is automatically or manually generated.

25. The computer system of claim 21 wherein determining whether to apply a customization to the primary business document further comprises:
retrieving a customization template; and
applying the customization template to the primary business document to generate the intermediary business document.

26. The computer system of claim 25, wherein the customization template is tailored to the business transaction.

27. The computer system of claim 21, wherein the primary business document or the intermediary business document is manually generated by selecting a desired business document output format.

28. The computer system of claim 21, wherein the intermediary business document is a duplicate or a modification of the primary business document.

29. The computer system of claim 28, wherein the intermediary business document has been modified to remove confidential information.

30. The computer system of claim 28, wherein the intermediary business document has been modified to add additional information that is useful to the intermediary.
